(19) United States
(12) Patent Application Publication
(10) Pub. No.: US 2003/0029815 A1
(43) Pub. Date: Feb. 13, 2003

(54) Method for separating oils from inorganic materials containing adhered oils

(76) Inventors: Satoshi Nakaoka, Kakogawa-shi (JP); Kazuhito Okada, Kakogawa-shi (JP); Hiroyuki Yoshida, Osaka (JP)

Correspondence Address: HOGAN & HARTSON L.L.P., 500 S. GRAND AVENUE, SUITE 1900, LOS ANGELES, CA, 90071-2611, US

(21) Appl. No.: 10/097,188

(22) Filed: Mar. 12, 2002

(30) Foreign Application Priority Data
Mar. 13, 2001 (JP) 2001-069882

(51) Int. Cl. B01D 43/00

(52) U.S. Cl. 210/774

(57) ABSTRACT

It is an object of the present invention to provide a simple method for effective, low-cost and safe separation and recovery of oils with excellent safety and quality, without causing degradation of oils or creating a danger of explosion or inflammation, from inorganic materials containing the adhered oils such as oils and fats, lipids, mineral oils, and the like. The method proposed hereby is for separating oils from inorganic materials by adding water to inorganic materials containing the adhered oils such as oils and fats, lipids, mineral oils, and the like, and conducting heating and pressurizing treatment under conditions of a temperature of 120-300° C. and a pressure of 0.2-13.0 MPa.

### BACKGROUND OF THE INVENTION

1. Field of the Invention

The present invention relates to a method for separating oils such as oils and fats, lipids, mineral oils, and the like from inorganic materials containing the adhered oils. More specifically, the present invention relates to a method for safe, simple, and low-cost separation of oils such as oils and fats, lipids, mineral oils, and the like from inorganic materials (inorganic adsorbents and the like) containing the adhered oils by using only water and using no organic solvents or alkali aqueous solutions. The oils such as oils and fats, lipids, mineral oils, and the like that have been separated and recovered by the method in accordance with the present invention contain no organic solvents or alkalis. Moreover, since they were subjected to sufficient sterilization and pasteurization by heating and pressurizing under high-temperature and high-pressure conditions, they have excellent safety and can be reused for a variety of applications. Furthermore, the inorganic materials such as inorganic adsorbents from which oils have been separated also contain a very small amount of adhered oils and contain no organic solvents or alkalis. In addition, they have been subjected to sufficient sterilization and pasteurization by heating and pressurizing under high-temperature and high-pressure conditions. Therefore, they can be effectively reused as inorganic adsorbents or for other applications.

2. Description of the Related Art

In the manufacture of soybean oil, corn oil, linseed oil, castor oil and other vegetable oils and fats, a crude oil extracted from plants is typically degummed and deoxidized to remove impurities such as phospholipids, fatty acids, microscopic amounts of heavy metals, and the like, and then refined (decolorized) by using an inorganic adsorbent such as active clay (acidic clay), active carbon, diatomaceous earth, silica-containing adsorbents, and the like, thereby removing colored substances or other impurities present in microscopic amounts in the oil. The decoloration is usually conducted with active clays.

When oils and fats are subjected to decoloration treatment (refining treatment) by using inorganic adsorbents, a method is widely used by which the inorganic adsorbents are added to oils and fats and heating and stirring are conducted in vacuum to adsorb and separate the impurities such as colorants that are present in oils and fats. The inorganic adsorbents that have adsorbed the impurities such as colorants are filtered in a filtration apparatus and discarded as cake-like waste inorganic adsorbent. The waste inorganic adsorbents discarded in the cake-like form usually have a large amount (about 40-80 wt. %) of adhered oil. This adhered oil is recovered to a possible degree by conducting purge treatment (blow treatment) by using air, steam, nitrogen, and the like. However, usually 30-40 wt. % oils still adhere to the inorganic adsorbents subjected to purging.

Part of waste inorganic adsorbents having oils and fats adhered thereto is used as construction aggregates or fermentation additives in the manufacture of compost. However, when the waste inorganic adsorbents are used as construction aggregates, the oils present therein often get in the way and degrade functions of the aggregates. Furthermore, in applications as fermentation additives for compost manufacture, since the adsorbents are used as additives, the amount used is very small. Another problem associated with the usage of waste inorganic adsorbents as fermentation additives for the manufacture of compost is that the plant growth can be easily impeded by oxidation of oils and fats contained in the waste. For this reason, waste inorganic adsorbents with oils and fats adhered thereto, which are discarded in large amounts, presently cannot be effectively used for construction aggregates or fermentation additives.

Accordingly, most of the waste inorganic adsorbents containing the adhered oils and fats are treated as industrial wastes and subjected to incineration or mixed with other wastes and subjected to incineration, followed by waste treatment of ash. Alternatively they are buried in a state in which they contain the adhered oils and fats. However, the incineration has environmental issues such as a loss of oil and fat resources, and air pollution such as contamination of atmosphere caused by burning. When the wastes are buried, they also cause environmental pollution such as degradation of soil environment by a large amount of oils and fats. Accordingly there has been a strong demand for methods for more effective treatment of waste inorganic adsorbents containing the adhered oils and fats.

With the foregoing in view, oils and fats adhered to waste inorganic adsorbents have been separated, recovered, and reused. The following methods have been used for the separation of oils and fats: (1) a method by which oils are extracted by using organic solvents such as hexane and the like and recovered; (2) a method comprising the steps of heating in a dilute alkali aqueous solution and recovering oils that rise to the top portion of the alkali aqueous solution; and (3) a method comprising the steps of adding an alkali aqueous solution, steam heating in an autoclave, and separating and recovering the oils.

However, with the above-described conventional method (1) using an organic solvent, because an organic solvent such as hexane is used which can cause inflammation or explosion, sufficient attention should be paid to safety from the standpoint of equipment or operation. In addition, the operation environment or ambient environment is easily degraded. Moreover, using organic solvents rises cost, the process and equipment become complex and the cost is raised because of additional process steps and apparatus for heat treatment that is required to recover the organic solvents used for oil extraction.

Furthermore, when oils and fats are edible oils and fats, organic solvents contained in the oils and fats have to be completely removed, because of safety concerns, when the oils and fats separated and recovered by solvent extraction are reused for food, and this operation is troublesome and disadvantageous in terms of cost.

The above-described methods (2) and (3) use alkali aqueous solutions. Therefore, the alkalis have to be removed form the separated and recovered oils and fats or inorganic adsorbent, and this operation is troublesome and costly.

With the foregoing in view, a method has been sought for simple, safe, and low-cost separation and recovery of oils and fats having excellent safety and suitable for effective utilization for respective intrinsic applications of oils and fats from inorganic adsorbents containing the adhered oils and fats. However, this search failed to yield a fully satisfactory method.

Moreover, not only in the field of vegetable oils and fats, but also in the field of other oils such as animal oils and fats, lipids, mineral oils, and the like, inorganic materials having a large amount of oils adhered thereto during preparation or processing of the oils have also been often discarded. In such cases, a method for simple, safe, and low-cost separation and recovery of oils from the inorganic materials containing the adhered oils has also been sought.

### SUMMARY OF THE INVENTION

It is an object of the present invention to provide a method for safe, effective, and low-cost separation and recovery of oils from inorganic materials containing the adhered oils such as oils and fats, lipids, mineral oils, and the like, without using organic solvents or alkali aqueous solutions.

It is another object of the present invention to provide a method for the separation and recovery of oils of high quality and excellent safety that can be effectively used as oils and fats, lipids, or mineral oils, and the like from inorganic materials containing the adhered oils such as oils and fats, lipids, mineral oils, and the like.

It is yet another object of the present invention to provide a method for the separation of oils from inorganic materials containing the adhered oils such as oils and fats, lipids, mineral oils, and the like and the recovery of the inorganic materials possessing all of the properties inherent to the inorganic materials, having excellent safety, and being suitable for reusage as inorganic adsorbents, soil modifiers, and for other applications.

The inventors have conducted an intensive study in order to attain the above-described objects. The results demonstrated that oils of excellent safety and high quality that can be effectively reused can be separated and recovered by a simple process at a low cost and with high safety, without using organic solvents or alkalis, if water is added to an inorganic adsorbent containing adhered oils and fats such as vegetable oils and fats and heating and pressurizing treatment is conducted at specific temperature and pressure. Further, the inventors have discovered that the inorganic adsorbent from which the oils and fats have been separated by such a heating and pressurizing treatment has good adsorption ability, can be effectively reused as an inorganic adsorbent and can be effectively used as a soil modifier or for other applications because it contains no organic solvents or alkalis. Furthermore, the inventors have also understood that the aforesaid specific heating and pressurizing treatment conducted after the addition of water can be used not only with respect to inorganic adsorbents containing the adhered oils and fats, but can be similarly effectively employed with respect to inorganic materials containing other oils such as lipids, mineral oils, and the like adhered thereto. Those findings led to the creation of the present invention.

Thus the present invention includes:

(1) A method for separating oils, wherein oils are separated from an inorganic material containing the adhered oils by adding water to the inorganic material and conducting heating and pressurizing treatment under conditions of a temperature of 120-300° C. and a pressure of 0.2-13.0 MPa.

The present invention also includes as specific embodiments thereof:

(2) The method for separating oils according to clause (1), wherein the oils are oils and fats, lipids, or mineral oils.

(3) The method for separating oils according to clause (1) or clause (2), wherein water is added at a ratio of 100-500 wt. parts to 100 wt. parts of the inorganic material containing the adhered oils.

(4) The method for separating oils according to any clause from clauses (1) to (3), wherein the heating and pressurizing treatment is conducted for 1-60 minutes.

(5) The method for separating oils according to any clause from clauses (1) to (4), wherein the inorganic material containing the adhered oil is an inorganic adsorbent used for oil refining.

(6) The method for separating oils according to clause (5), wherein said inorganic material is at least one inorganic adsorbent selected from active clays, active carbon, diatomaceous earth, bentonite, silica-containing adsorbents, calcium carbonate, and titanium oxide.

(7) A method for separating vegetable oils and fats from an inorganic adsorbent by adding water at a ratio of 100-500 wt. parts to 100 wt. parts of the inorganic adsorbent containing the adhered vegetable oils and fats and conducting heating and pressurizing treatment under the conditions of a temperature of 120-300° C. and a pressure of 0.2-13.0 MPa.

(8) The method for separating vegetable oils and fats according to clause (7), wherein the inorganic adsorbent containing the adhered vegetable oils and fats is a waste inorganic adsorbent used for refining of vegetable oils and fats.

(9) The method for separating vegetable oils and fats according to clause (7) or clause (8), wherein the vegetable oils and fats are edible vegetable oils and fats.

### DESCRIPTION OF THE PREFERRED EMBODIMENTS

The present invention will be described below in greater detail.

In accordance with the present invention, oils are separated from an inorganic materials by adding water to the inorganic material containing the adhered oils and conducting heating and pressurizing treatment under conditions of a temperature of 120-300° C. and a pressure of 0.2-13.0 MPa. In accordance with the present invention, water added to the system assumes a subcritical state under the above-mentioned temperature and pressure. The temperature and pressure as referred to in accordance with the present invention are the temperature and pressure inside a container for heating and pressurizing treatment.

Representative examples of the adhered “oils” contained in inorganic materials include oils and fats, lipids, or mineral oils.

Among them, the oils and fats may be edible or non-edible oils and fats. Furthermore, the oils and fats may be vegetable or animal oils and fats.

Examples of edible oils and fats include vegetable oils and fats such as soybean oil, rape-seed oil, cotton-seed oil, corn oil, sunflower oil, safflower oil, olive oil, sesame oil, palm oil, coconut oil, peanuts oil, and the like, and animal oils and fats such as lard, head, mutton, fish oil, whale oil, and the like.

Examples of non-edible oils and fats include castor oil, linseed oil, turpentine oil, and the like.

Examples of lipids include phospholipids, glycolipids, waxes, steroids, carotenoids, terpenes, neutral lipids, and the like.

Examples of mineral oils include petroleum oil and the like.

Representative examples of “inorganic materials containing the adhered oils”, which are the subject of treatment in accordance with the present invention, include waste inorganic materials containing the adhered oils such as oils and fats, lipids, mineral oils, and the like, which are discarded in the preparation or processing of oils such as the above-described oils and fats, lipids, mineral oils, and the like.

No specific limitation is placed on the amount of adhered oils in the “inorganic materials containing the adhered”, and this amount can vary depending on the type of process or type of treatment in which the inorganic material is discarded.

The heating and pressurizing treatment in accordance with the present invention may be conducted after a part of oils has been separated in advance from the inorganic material by purge treatment (blow treatment) of the inorganic materials containing the adhered oils with air, nitrogen, steam, and the like, or the inorganic materials containing the adhered oils may be directly subjected to the heating and pressurizing treatment, without the purge treatment. The efficiency of oil removing treatment can be increased if the amount of oils that adhered to the inorganic material is decreased in advance by conducting purge treatment with air, nitrogen, steam, and the like.

When the inorganic materials containing the adhered oils are inorganic adsorbents containing the adhered vegetable oils and fats, the amount of oils that adhered to the inorganic adsorbent is typically about 40-80 wt. % prior to the above-described purge treatment (blow treatment), and the amount of oils that adhered to the inorganic adsorbent is typically about 30-40 wt. % after the purge treatment. In accordance with the present invention, any of those can be used, but it is preferred that the inorganic adsorbent be used in which the amount of oil was decreased to about 30-40 wt. % by purge treatment.

Any inorganic material containing the adhered oils may be the inorganic material in the “inorganic material containing the adhered oils” used in accordance with the present invention, and it is preferred that the inorganic material be in the form of granule or a powder. Inorganic adsorbents are representative examples of such inorganic materials. Specific examples of inorganic adsorbents include active clay (acidic clay), active carbon, diatomaceous earth, bentonite, silica-containing adsorbents, calcium carbonate, titanium oxide, and the like.

Among them, the method in accordance with the present invention is suitable as a separation method for separating oils and fats from inorganic adsorbents (waste inorganic adsorbents) such as active clay, active carbon, diatomaceous earth, bentonite, silica-containing adsorbent, and the like that contain the adhered oils and fats, and is especially suitable as a method for separating edible oils and fats from active clays containing the adhered vegetable edible oils and fats. Active clays used for decoloration treatment of oils and fats are finely powdered solid materials having excellent adsorption ability with respect to colorants, that were activated by chemically treating natural raw materials containing montmorillonite clays as the main components with an acid such as sulfuric acid, hydrochloric acid, and the like. The adsorption capacity of active clays differs depending on intensity of acid treatment, and the specific surface area becomes larger and the adsorption capacity becomes greater as the intensity of acid treatment hardens. The chemical composition mainly consists of silicic acid SiO₂H₂O, 70-80 wt. %, and aluminum oxide Al₂O₃, 10-13 wt. %.

If the temperature of the heating and pressurizing treatment during separation of oils from the inorganic material containing the adhered oils is less than 120° C., the oil recovery ratio decreases and the restoration of physical properties of the inorganic materials recovered after the separation of oils is degraded. In particular, when the inorganic material is an inorganic adsorbent, the restoration of adsorption capacity is degraded. On the other hand, if the temperature of the heating and pressurizing treatment is above 300° C., pyrolysis and/or hydrolysis of oils becomes significant and the quality of separated and recovered oils is decreased.

Furthermore, if the pressure of the heating and pressurizing treatment is less than 0.2 MPa, the recovery ratio of oils is decreased and the restoration of physical properties of inorganic materials recovered after the separation of oil is degraded. In particular, when the inorganic material is an inorganic adsorbent, the restoration of adsorption capacity is degraded. On the other hand, if the pressure of the heating and pressurizing treatment is above 13.0 MPa, pyrolysis and/or hydrolysis of oils becomes significant and the quality of separated and recovered oils is decreased.

In accordance with the present invention, when the inorganic material containing the adhered oils is an inorganic material (in particular, active clay) containing the adhered oils and fats, in particular, vegetable oils and fats, from the standpoint of separation and recovery ratio of oils and fats and restoration ability of adsorption capacity of inorganic adsorbents, it is preferred that the heating and pressurizing treatment be conducted at a temperature of 150-250° C. and a pressure of 0.5-4.0 MPa, more preferably, at a temperature of 160-200° C. and a pressure of 0.6-1.6 MPa.

The amount of water used during the heating and pressurizing treatment can vary depending on the type and amount of oils that adhered to the inorganic materials and the type of inorganic materials. However, from the standpoint of oils separation ratio, quality of separated oils, and properties of inorganic materials after the oils have been separated, it is typically preferred that the above-described heating and pressurizing treatment be conducted upon addition of water at a ratio of 100-500 wt. parts of water per 100 wt. parts of inorganic material containing the adhered oils. It is even more preferred that the heating and pressurizing treatment be conducted upon addition of water at a ratio of 150-350 wt. parts of water per 100 wt. parts of inorganic material containing the adhered oils. In particular, when the inorganic material containing the adhered oils is an inorganic material (in particular, active clay) containing the adhered vegetable oils and fats, it is especially preferred that the heating and pressurizing treatment be conducted with amount of water used within the above-described range.

The duration of the heating and pressurizing treatment can vary depending on the type or amount of oils that adhered to the inorganic materials and the type of inorganic materials. However, from the standpoint of treatment efficiency, oil separation ratio, quality of separated oils, and properties of inorganic materials after the oils have been separated, it is typically preferred that the duration of the heating and pressurizing treatment be about 1-60 minutes, in particular, 2-10 minutes.

The heating and pressurizing treatment for the separation of oils from inorganic materials and the separation and recovery of oils and inorganic materials that are conducted thereafter may be conducted in either a batch mode or a continuous mode.

For example, when they are conducted in a batch mode, the operations of adding water to the inorganic material containing the adhered oils and conducting heating and pressurizing treatment under the above-described conditions under which the water is in a subcritical state separate the oils adhered to the inorganic material and transfer them to the steam phase. Therefore, if then the temperature inside the apparatus used for the heating and pressurizing treatment or the temperature in the system after the removal from the apparatus is lowered to no more than 100° C., the steam phase is transformed into an aqueous phase, and oils with a specific gravity typically lower than that of water float in the upper portion of the aqueous phase and are separated in a liquid state or in a solid state (when the temperature of aqueous phase is lower than the melting temperature of oils). On the other hand, the inorganic material which has a large specific gravity precipitates to the lower portion of aqueous phase as a precipitate.

In both the batch mode and the continuous mode, the aqueous phase and oil phase in the upper portion and the precipitated inorganic material can be separated and recovered inside the heating and pressurizing apparatus or outside the heating and pressurizing apparatus and then the oil can be recovered in a very easy manner by separation from the aqueous phase.

Furthermore, the separately recovered inorganic material can be effectively reused according to the type of the inorganic material, for example, as an inorganic adsorbent for refining of oils, by drying and/or calcining or dry distillation.

No specific limitation is placed on the type and structure of heating and pressurizing apparatus used for the heating and pressurizing treatment, and any heating and pressurizing apparatus can be used, provided it is suitable for heating and pressurizing treatment of a mixture of water and an inorganic material containing the adhered oils under conditions of a temperature of 120-300° C. and a pressure of 0.2-13.0 MPa. For example, an autoclave, a hot-water boiler, and the like can be used. The heating and pressurizing apparatus may have a discharge opening for water and oils which is separate from the discharge opening for the inorganic material or it may have a system in which one discharge opening is used for water, oils, and inorganic material. Furthermore, means for stirring the contents of the apparatus may be provided inside the heating and pressurizing apparatus.

The oils separated and recovered in the above-described manner contain no organic solvents or alkalis and have excellent safety and handleability. Therefore, they can be effectively reused for edible oils and fats or for other application, depending on the type of the oils. Furthermore, the inorganic materials separated and recovered in the above-described manner also contain no organic solvents or alkalis and have excellent safety and handleability, and the amount of oils that adhered thereto is reduced significantly. Therefore, they can be directly dried and effectively reused as inorganic adsorbents for refining of oils, soil modifiers, and for other applications depending on the type of inorganic material.

### EXAMPLES

The present invention will be described below in greater details based on examples thereof, but the present invention is not limited to the below-described examples.

In the examples presented below, the content of oil in active clay, the acid value and peroxide value of oils and fats, and the decoloration and adsorption ability of active clay were measured in the following manner.

[Content of Oil in Active Clay]

Measurements were conducted by a Soxhlet oils and fats extraction method specified in Section “1.5. Oils” of “Standard Methods for Analysis of Oils and Fats (I)” established by the Japan Oil Chemists' Society.

[Acid Value of Oils and Fats]

Measurements were conducted by a potassium hydroxide titration method specified in Section “2.3. Acid value” of “Standard Methods for Analysis of Oils and Fats (I)” established by the Japan Oil Chemists' Society.

[Peroxide Value of Oils and Fats]

Measurements were conducted by an acetic acid—isooctane method specified in Section “2.5.2. Peroxide value” of “Standard Methods for Analysis of Oils and Fats (I)” established by the Japan Oil Chemists' Society.

[Decoloration and Adsorption Ability of Active Clay]

For getting the color tone (R value and Y value determined by a Lovibond colorimetry) of oils and fats, the necessary amount of “a fresh active clay”, which has not yet been used, and “a regenerated active clay” were measured, which were described as “W₀”, “W₁” respectively. Then, the ratio W₀/W₁ ×100 (%) was determined, and the value obtained was considered as a decoloration and adsorption ability (%) of regenerated active clay.

More specifically, for example, when a total of 100 g of “fresh active clay” had to be used to obtain oils and fats with a specific color tone (R value 1.5, Y value=15 determined by Lovibond colorimetry) and a total of 200 g of “a regenerated active clay” had to be used to obtain oils and fats with a color tone (R value=1.5, Y value=15) equivalent thereto, the decoloration and adsorption ability of regenerated active clay can be calculated as (100 g/200 g)×100=50%.

### Example 1

(1) Active clay, (grade “V₂”, manufactured by Mizusawa Chemical Co., Ltd.) used for decoloration treatment in the refining of palm oil, was filtered and purged with air and nitrogen to remove oils. As a result, oil-containing active clay (waste clay) with an oil content of about 35 wt. % was obtained.

(2) A total of 200 g of pure water was added to 100 g of waste clay obtained in section (1), the components were placed in an autoclave with a capacity of 500 mL, the temperature inside the autoclave was raised to 180° C. (pressure of 1 MPa), and the system was maintained for 5 minutes at this temperature and pressure.

(3) Then, the temperature inside the autoclave was lowered to 60° C. and the entire contents was removed from the autoclave and allowed to stay in a stationary state. As a result, the system was separated in the following layers, starting from the top: an oil layer, a water layer, and an active clay layer (precipitate). Then, the oil of the upper layer and active clay of the lower layer were individually separated and recovered.

(4) The acid value and peroxide value of the oil (palm oil) separated and recovered in section (3) above were measured by the above-described methods. The results obtained are shown in Table 1.

(5) Furthermore, the active clay separated and recovered in section (3) above was dried for 60 minutes at a temperature of 60° C. and the content of oil in the active clay and the decoloration and adsorption ability of active clay were measured by the above-descried methods. The results obtained are shown in Table 1 below.

### Comparative Example 1

(1) A total of 200 g of hexane was added to 100 g of active clay containing the adhered palm oil, which was obtained in section (1) of Example 1. The components were placed in a flask with a capacity of 500 mL and the contents was heated to a temperature of 40° C. The flask was then sealed with a plug, stirred for 5 minutes, and allowed to stay in a stationary state. The top hexane layer (containing dissolved palm oil) and the precipitated active clay layer were individually recovered.

(2) Hexane solution containing palm oil that was recovered in section (1) above was heated to a temperature of 60° C., the hexane was distilled off, and the residue was recovered as palm oil. The acid value and peroxide value thereof were measured by the above-described method. The results obtained are shown in Table 1. The palm oil thus obtained contained a very small amount of hexane (hexane content 3.5 wt. %).

(3) Furthermore, the active clay recovered in section (1) above was dried for 60 minutes at a temperature of 60° C. Then, the amount of oil (content of palm oil) contained in the active clay and the decoloration and adsorption ability of active clay were measured by the above-described methods. The results obtained are shown in Table 1. The active clay after drying contained a very small amount of hexane (hexane content 0.1 wt. %).

TABLE 1

| | Example | Comparative |
|---|---|---|
| | 1 | Example 1 |
| Quality of recovered palm oil: | 6.5 | 2.4 |
| Acid value | | |
| Peroxide value | 0.10 | 0.45 |
| Physical properties of oil removed active clay: | 9.3 | 8.7 |
| Oil content (wt. %) | | |
| Decoloration and adsorption ability (%) | | |
| Palm oil decoloration and adsorption ability | 50.0 | 50.0 |
| Rape-seed oil decoloration and adsorption | 60.0 | 60.0 |
| ability | | |

The above-described results obtained in Example 1 and Comparative Example 1 demonstrate that the active clay oil removing ratio, acid value and peroxide value of the separated and recovered oil (palm oil), oil content in the active clay, and decoloration and adsorption ability obtained in Example 1 in which water was added to a waste active clay (inorganic adsorbent) containing the adhered oil and heating and pressurizing treatment was conducted at the prescribed temperature and pressure specified by the present invention were almost the same as those obtained in Comparative Example 1 (conventional example) in which oil removing was conducted by using hexane (organic solvent).

Further, since the oil (palm oil) separated and recovered in Example 1 contained absolutely no organic solvents such as hexane, it has excellent safety. Moreover, because the acid value and peroxide value thereof were sufficiently low allowing the oil to be used for food, it can be effectively used as an edible oil.

In addition, the active clay separated and recovered in Example 1 contained no organic solvent, had excellent safety and a high decoloration and adsorption ability. Therefore, it can be reused for decoloration treatment of edible oils and fats. Moreover, the active clay separated and recovered in Example 1 had a low oil content, contained no organic solvents, and had excellent safety. Therefore, not only it can be reused for decoloration treatment of edible oils and fats, but it can be safely and effectively used for other applications, for example, as a soil modifier.

### Example 2

(1) Tests were conducted by adding a total of 100 g of pure water to 100 g of waste clay containing the adhered palm oil, which was obtained in section (1) of Example 1, placing the components in an autoclave with a capacity of 500 mL, setting the temperature and pressure inside the autoclave to respective temperatures and temperatures and pressures shown in Table 2 below, and maintaining each system for 5 min.

(2) In each of the tests, the temperature inside the autoclave was lowered to 60° C. and the entire contents was removed from the autoclave and allowed to stay in a stationary state. The oil of the upper layer and the precipitated active clay of the lower layer were individually separated and recovered. The acid value and peroxide value of the separated and recovered oil (palm oil) were measured by the above-described methods. The results obtained are shown in Table 2 below.

TABLE 2

| | Conditions of heating and | | | | | | |
|---|---|---|---|---|---|---|---|
| | pressurizing treatment | | | | | | |
| Temperature (° C.) | 100 | 120 | 150 | 200 | 250 | 300 | 320 |
| Pressure (MPa) | 0.10 | 0.20 | 0.48 | 1.55 | 3.98 | 8.59 | 11.30 |
| Quality of recovered palm oil: | No | 3.0 | 3.0 | 8.5 | 12.0 | 19.5 | 33.5 |
| Acid value | oil | 0.1 | 0.1 | 0.1 | 0.7 | 0.8 | 1.2 |
| Peroxide value | separation | | | | | | |
| Physical properties of oil removed active clay: | | 22.5 | 11.0 | 9.0 | 9.0 | 8.8 | Black |
| Oil content (wt. %) | | | | | | | incineration |
| Decoloration and adsorption ability (%) | | | | | | | |
| Palm oil decoloration and adsorption ability | — | 30 | 50 | 60 | 60 | 60 | |
| Rape-seed oil decoloration and adsorption ability | — | 30 | 60 | 60 | 60 | 65 | |

The results presented in Table 2 demonstrate that oil with excellent quality and low acid value and peroxide value can be separated and recovered and also a reusable inorganic material with a low oil content and a high decoloration and adsorption ability can be separated and recovered by adding water to the inorganic material containing the adhered oil and conducting heating and pressurizing treatment at a temperature of 120-300° C. and under a pressure of 0.2-13.0 MPa.

With the method in accordance with the present invention, oils can separated and recovered safely, effectively, and at a low cost, without using organic solvents or alkali aqueous solution, from inorganic materials containing the adhered oils such as oils and fats, lipids, mineral oils, and the like. In particular, in accordance with the present invention, separation of oils is conducted by using only water, that is, without using organic solvents that pose a danger of inflammation or explosion. Therefore, the present invention can be implemented with a simple apparatus, without cost increase associated with the utilization of organic solvents and danger of inflammation and explosion, does not require equipment or processes for removing organic solvents from the separated oils, and has excellent safety and sanitary ability.

Further, with the present invention, high-quality and highly safe oils (oils and fats, lipids, mineral oils, and the like) subjected to sufficient sterilization and pasteurization by heating and pressurizing treatment at a high temperature and under a high pressure can be separated and recovered, without using organic solvents or alkalis, from inorganic materials containing the adhered oils such as oils and fats, lipids, mineral oils, and the like. Therefore, the oils separated and recovered by the method in accordance with the present invention are suitable for a variety of applications. In particular, when the oils which are to be separated and recovered are edible oils and fats, they are safe and can be directly used as edible oils and fats because they contain no organic solvents or alkalis and were subjected to sufficient sterilization and pasteurization.

Moreover, the inorganic materials, after the oils have been separated therefrom by the method in accordance with the present invention, have a very small amount of adhered oils and have all of the properties inherent to such inorganic materials. Further, since the inorganic materials, after the oils have been separated therefrom, contain no organic solvents of alkalis and have been subjected to sufficient sterilization and pasteurization by the above-mentioned heating and pressurizing treatment at a high temperature and under a high pressure, they have excellent safety. Therefore, the inorganic materials that were recovered by the method for separating oils in accordance with the present invention can be effectively reused for inorganic adsorbents, soil modifiers, and for other applications.

What is claimed is:

1. A method for separating oils, wherein oils are separated from an inorganic material containing the adhered oils by adding water to the inorganic material and conducting heating and pressurizing treatment under conditions of a temperature of 120-300° C. and a pressure of 0.2-13.0 MPa.

2. The method for separating oils according to claim 1, wherein the oils are oils and fats, lipids, or mineral oils.

3. The method for separating oils according to claim 1 or claim 2, wherein water is added at a ratio of 100-500 wt. parts to 100 wt. parts of the inorganic material containing the adhered oils.

4. The method for separating oils according to any claim from claims 1 to 3, wherein the heating and pressurizing treatment is conducted for 1-60 minutes.

5. The method for separating oils according to any claim from claims 1 to 4, wherein the inorganic material containing the adhered oil is an inorganic adsorbent used for oil refining.

6. The method for separating oils according to claim 5, wherein said inorganic material is at least one inorganic adsorbent selected from active clays, active carbon, diatomaceous earth, bentonite, silica-containing adsorbents, calcium carbonate, and titanium oxide.

7. A method for separating vegetable oils and fats from an inorganic adsorbent by adding water at a ratio of 100-500 wt. parts to 100 wt. parts of the inorganic adsorbent containing the adhered vegetable oils and fats and conducting heating and pressurizing treatment under the conditions of a temperature of 120-300° C. and a pressure of 0.2-13.0 MPa.

8. The method for separating vegetable oils and fats according to claim 7, wherein the inorganic adsorbent containing the adhered vegetable oils and fats is a waste inorganic adsorbent used for refining of vegetable oils and fats.

9. The method for separating vegetable oils and fats according to claim 7 or claim 8, wherein the vegetable oils and fats are edible vegetable oils and fats.
